(19) United States
(12) Patent Application Publication
(10) Pub. No.: US 2025/0220017 A1
(43) Pub. Date: Jul. 3, 2025

(54) CUSTOMER ACCESS MANAGEMENT SYSTEM AND METHOD

(71) Applicant: Charles River Laboratories International, Inc., Wilmington, MA (US)

(72) Inventors: Ronald Wayne Litzenberger, Huntsville, AL (US); John Allen, Tipperary (IE); Alissa Renee Mague, Twinsburg, OH (US)

(73) Assignee: Charles River Laboratories International, Inc., Wilmington, MA (US)

(21) Appl. No.: 18/397,630

(22) Filed: Dec. 27, 2023

(51) Int. Cl. H04L 9/40; G06F 16/901

(52) U.S. Cl. CPC H04L 63/102; G06F 16/9024

(57) ABSTRACT

A method of controlling access to resources provided to a customer via a host includes generating a graph structure defining access control to the resources. The graph structure designates a user associated with the customer as a manager. The graph structure includes a user node associated with the user designated as the manager, resource nodes, each resource node associated with a respective resource among the resources, and edges, each edge extending from the user node associated with the user designated as the manager to each of the resource nodes. Each edge specifies an edge value that defines access provided to the user designated as the manager for the respective resource among the resources. The method also includes modifying the graph structure based on input from the user designated as the manager to modify the access control to the resources.

### BACKGROUND

In several scenarios, an enterprise (e.g., host) may store data that is provided or commissioned for generation by a customer. While the host stores the data (directly or via a third party), aspects of access to the data are dictated by the customer. According to a prior paradigm, the data may be stored in servers that are directly managed by the host, and host personnel may be tasked with managing access to different elements of the data based on customer specifications. As customer requests are submitted (e.g., remove a previously authorized user's access to particular data), the host personnel may modify access control at the relevant servers. Implementation of access control via host personnel may be more challenging to implement with the increasing use of software as a service (SaaS).

### SUMMARY

In some embodiments, a system and method is provided for access management via a graphical specification.

According to one or more embodiments, a method of controlling access to resources provided to a customer via a host includes generating a graph structure defining access control to the resources. The graph structure designates a user associated with the customer as a manager. The graph structure includes a user node associated with the user designated as the manager, resource nodes, each resource node associated with a respective resource among the resources, and edges, each edge extending from the user node associated with the user designated as the manager to each of the resource nodes. Each edge specifies an edge value that defines access provided to the user designated as the manager for the respective resource among the resources. The method also includes modifying the graph structure based on input from the user designated as the manager to modify the access control to the resources.

According to another embodiment, a non-transitory computer-readable medium stores instructions that, when processed by one or more processors, cause the one or more processors to implement a method of controlling access to resources provided to a customer via a host. The method includes generating a graph structure defining access control to the resources. The graph structure designates a user associated with the customer as a manager. The graph structure includes a user node associated with the user designated as the manager, resource nodes, each resource node associated with a respective resource among the resources, and edges, each edge extending from the user node associated with the user designated as the manager to each of the resource nodes. Each edge specifies an edge value that defines access provided to the user designated as the manager for the respective resource among the resources. The method also includes modifying the graph structure based on input from the user designated as the manager to modify the access control to the resources.

The foregoing has outlined some of the pertinent features of the disclosed subject matter. These features are merely illustrative.

### BRIEF DESCRIPTION OF THE DRAWINGS

The examples described throughout the present document will be better understood with reference to the following drawings and descriptions. In the figures, like-referenced numerals designate corresponding parts throughout the different views.

FIG. 1 is a block diagram of a system in which customer access management via a graph structure is implemented according to some embodiments;

FIG. 2A shows an exemplary user interface screen facilitating a customer adding users according to some embodiments;

FIG. 2B shows an exemplary user interface screen facilitating a customer managing access and permissions to a specified resource according to one or more embodiments;

FIG. 3 is a process flow of a method of providing customer access management of resources controlled by a host system and implemented via a graph structure according to some embodiments;

FIG. 4 shows aspects of an exemplary system in which customer access management implemented via a graph structure according to some embodiments;

FIG. 5A shows aspects of an exemplary system implementing a Merkel tree to decentralize the graph structure according to embodiments;

FIG. 5B shows aspects of the exemplary system of FIG. 5A in a cross-cloud implementation according to embodiments;

FIG. 6 shows aspects of an exemplary system implementing a Merkel tree for development activity according to embodiments;

FIG. 7 shows an exemplary graph structure that may be an initial graph structure generated by a host system according to some embodiments;

FIG. 8 shows an exemplary graph structure that may result from a customer adding users according to some embodiments;

FIG. 9 shows an exemplary graph structure that may result from the host system removing access according to some embodiments;

FIG. 10 shows an exemplary graph structure with additional resources and permissions that may result from host and customer actions according to some embodiments;

FIG. 11 shows an exemplary graph structure indicating removal of access to a resource by the host according to some embodiments; and

FIG. 12 shows an exemplar graph structure that may result from removal of access by a customer and addition of links among resources by the host system according to some embodiments.

### DETAILED DESCRIPTION

Reference will now be made to the drawings to describe the present disclosure in detail. It will be understood that the drawings and exemplified embodiments are not limited to the details thereof. Modifications may be made without departing from the spirit and scope of the disclosed subject matter.

As noted, data may be provided to or generated by a host and permissions for access to the data may be specified by a customer. More broadly, a customer may wish to implement access control to a resource (e.g., application, output of an application, workspace, document) that is stored by or available via a host. In a SaaS paradigm, a multi-tenant approach may be used. That is, resources may be accessed by multiple customers of the host while the resource itself may be stored by a third party (e.g., in a cloud-based server) rather than by the host. For example, the host may make a model available in a SaaS platform. While the model may be accessible by multiple customers, each may generate different output with the model that should not be accessible by the others. In addition, each customer may wish to specify different types of access to its resources for different users on the customer side. The SaaS approach presents additional challenges to access control implemented via host personnel as compared with the host server approach. In addition, management of access via host personnel puts the responsibility for carrying out access preferences of the customer entirely on the host. This may increase chances of errors, as well as delays in implementation.

Embodiments detailed herein relate to access management implemented via a graph structure. The known graph structure generally involves vertices (called nodes) and edges that connect a pair of the nodes. Each edge associated with each pair of nodes may have an edge value (e.g., label, numeric attribute). Aspects of the customer access management involve representing different users and available resources as interconnected nodes, with edges that connect the nodes having edge values that specify the relationship between the nodes. That is, for example, the edge value of an edge from a node representing a particular user to a node representing a particular resource (e.g., study result, document) may indicate the permission level and access of that particular user for that particular resource. According to embodiments, creating or modifying permissions and access corresponds to adding or removing nodes or edges.

Another exemplary aspect involves a customer user interface that facilitates control of aspects of the graph structure by a user on the customer side. Customer, as used herein, may refer to a collective or enterprise with multiple associated individual users, giving rise to the need to manage access among the multiple users. The graph structure may be initially generated, maintained, and implemented by the host, but may be modified, at least in part, by one or more users at the customer. More specifically, the initial graph structure may include one or more nodes corresponding to users associated with the customer who have the requisite permissions to modify the graph structure by adding or removing other users and setting the permission levels of those other users, for example. The permissions may be specified by edge values from the one or more nodes representing the users associated with the customer to one or more resources. By allowing the customer to add or remove additional users (resulting in adding or removing nodes to the graph structure) and specify each additional user's level of access to each resource (resulting in assigning or modifying the edge value assigned to each edge between an additional user and a resource), some of the responsibility for access management is shifted from the host to the customer.

In some embodiments, users of the customer may access the host via another host (e.g., another SaaS application). In this case, the host that provides access to resources may directly interact with the other host (e.g., one or more processors) rather than directly with users of the customer. In some embodiments, the graph structure implemented by the host to determine access and permissions to resources may be distributed and managed using a Merkel tree to validate requested access to a specific resource more quickly than in a centralized approach.

Exemplary embodiments may include the use of a JavaScript Object Notation (JSON) web token (JWT) at both a front-end (to determine the user interface options available to a given user) and a back-end (to determine resources accessible by the given user). That is, according to the exemplary embodiments, the access and permissions defined in the graph structure may be implemented via a unique JWT assigned to each user. While one or more users associated with the customer (or another host) may modify aspects of the graph structure via the user interface, based on their access and permissions, the ultimate access control remains with the host. For example, the host may remove a node associated with the user associated with the customer or change edge values originating from the user associated with the customer to modify or remove the ability of the user associated with the customer to modify access control for other users associated with the customer.

The graph structure according to aspects detailed herein facilitates real-time, granular, and shared access control by the customer and host that improves management of resources.

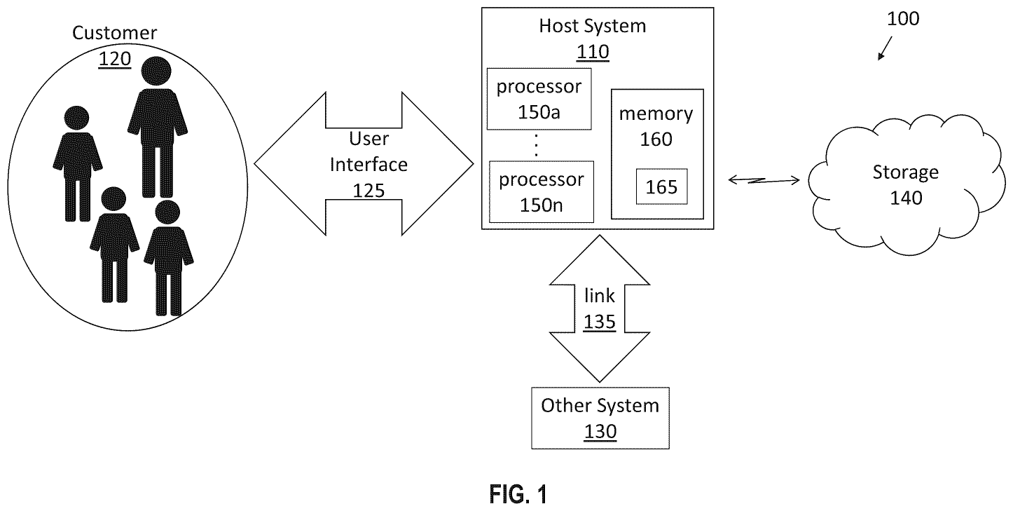

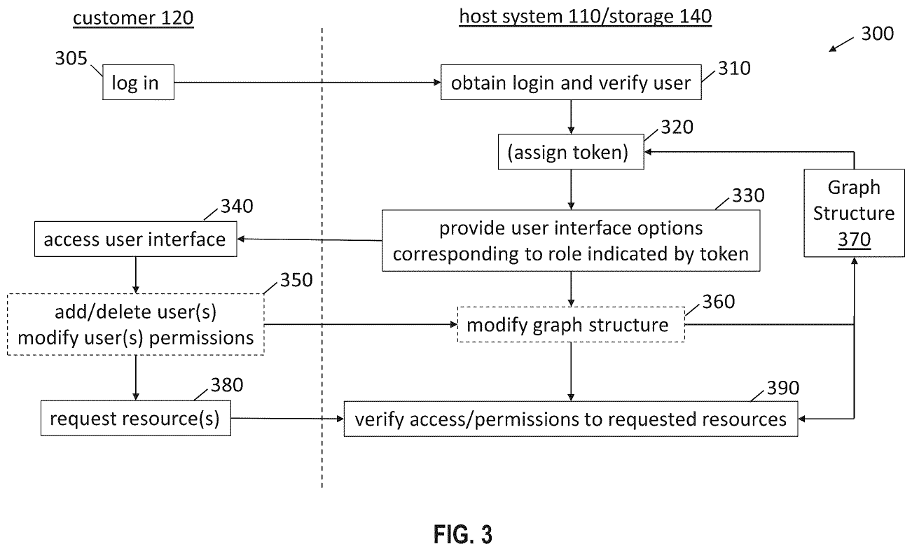

FIG. 1 is a block diagram of a system 100 in which customer access management via a graph structure 370 (FIG. 3) is implemented according to some embodiments. The system 100 includes a host system 110 that may generate and ultimately control resources that may be stored in storage 140 (e.g., cloud-based storage). The host system 110 may include one or any number of processors 150a through 150n (generally processor 150), as shown. The host system 110 may also include memory 160 including a non-transitory computer-readable medium 165 to store instructions implemented by one or more processors 150 to facilitate the customer access management via a graph structure 370. The exemplary illustration in FIG. 1 is not intended to limit the host system 110, which may be distributed according to embodiments. When a processor 150 is referenced, any one or more of the processors 150 of the host system 110 may be involved in implementing the functionality.

One of more customers 120 may access the resources via a user interface 125. Customer 120 may refer to an enterprise with multiple individual users, for example. One or more other systems 130 may access the resources via a link 135 that facilitate service-to-service (S2S) authorization and communication. One of these other systems 130 may facilitate an enterprise with users to access the resources controlled by the host system 110. According to embodiments detailed with reference to the remaining figures, the user interface 125 and the link 135 allow authorized users outside the host system 110 to specify access and permissions to one or more resources controlled by the host system 110 by other users. The access and permissions are implemented via a graph structure that may be modified in real-time, allows different access and permissions to resources on a granular level (e.g., folder), and may be used in an SaaS environment.

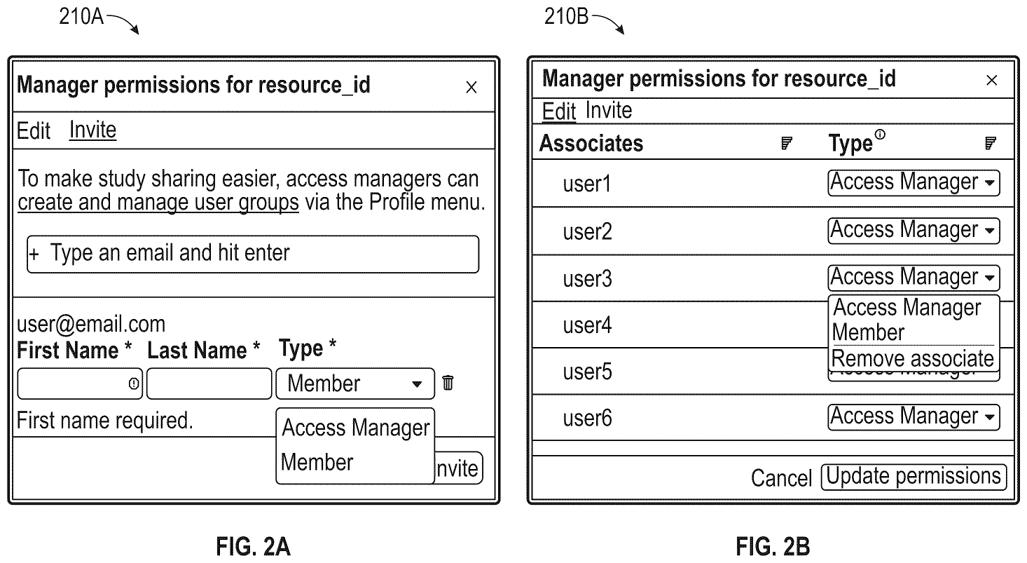

FIG. 2A shows an exemplary user interface screen 210A for adding users according to some embodiments. This aspect of an exemplary user interface 105 represents some of the access management provided to the customer 120 according to exemplary embodiments. The exemplary user interface screen 210A may only be provided to users (e.g., on the customer 120 side, using another system 130) who have been designated as access managers by the host system 110. The designation as an access manager is an exemplary designation used for explanatory purposes to differentiate access and permissions of members, who may be other users given access only to resources, from access and permissions of access managers, who may add, remove, or modify member access and permissions, as well as access resources. The exemplary interface screen 210A shows that a name and email address may be provided for a new user of the resources of the host system 110 and the type of the user (e.g., designation as member or access manager) may be specified. The exemplary interface screen 210A shows that the new user may be added for a specific resource with a given resource identifier (indicated as resource_id).

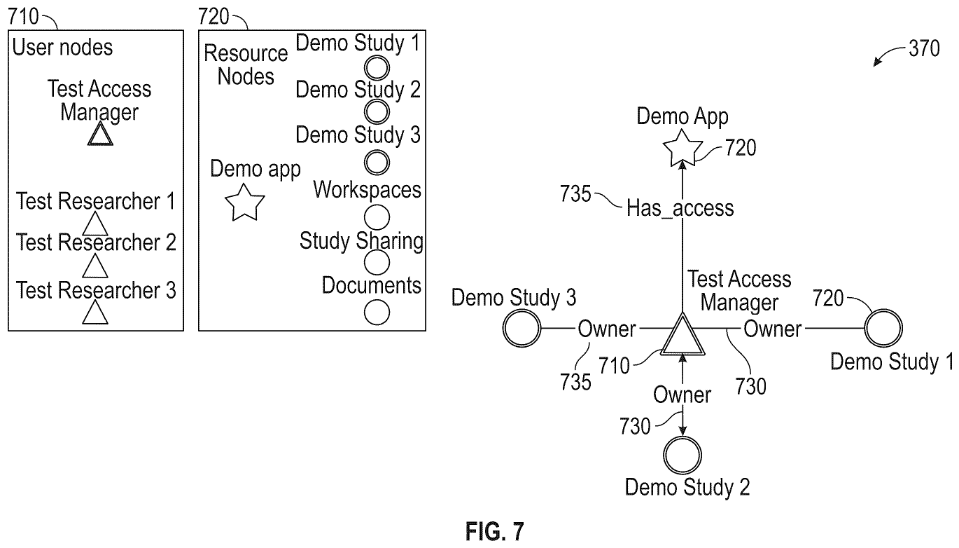

The identified resource may represent all the data, documents, and other entities of the customer 120 controlled by the host system 110 or may be some subset. Thus, the granularity of the access control available to an access manager of the customer 120 may correspond with the granularity in the options of the user interface 105. When a customer 120 has access to a set of resources of the host system 110, this type of user interface 105 may provide access and permission controls on a granular level within the set of resources. The addition of a user may result in the addition of a node in the graph structure 370 (FIG. 3) defining access control to the identified resource. The specification of the type of the new user may result in the specification of an edge value 735 for an edge 730 between a node 710 representing the user and a node representing a resource 720, as shown in FIGS. 7-12.

FIG. 2B shows an exemplary user interface screen 210B for managing access and permissions to a specified resource according to one or more embodiments. Like the exemplary user interface screen 210A, this exemplary user interface screen 210B may only be provided to a user designated as an access manager. A specific resource may be identified to see all the users with access to the resource and their user type (e.g., designation as access manager or member) specific to that resource. As the exemplary interface screen 210B indicates, an access manager may change the user type of a particular user or remove the access of a particular user to the resource altogether. These changes may result in the modification of an edge value 735 between a node 710 representing the particular user and the node 720 representing the resource 720 in a corresponding graph structure 370.

FIG. 3 is a process flow of a method 300 of providing customer access management of resources controlled by a host system 110 and implemented via a graph structure 370 according to some embodiments. A dashed line is used to distinguish processes performed at the customer side from those associated with the host system 110. Processes associated with the host system 110 are not limited to being performed in one or more processors at a host system site. The processes may also be distributed and performed using cloud-based applications and the storage 140, for example, and may involve third-party applications.

At 305, a user associated with a customer 120 may log in. Specifically, the user may provide credentials (e.g., username, password) that are verified, at 310, via the host system 310. For any new customer 120 and/or new resources to be provided to a customer 120, the host system 110 may only designate one or more users associated with the customer 120 as an access manager. Using the method 300 and, specifically, processes described with reference to 350 and user interface screen 210A, a designated access manager of the customer 120 may add additional users associated with the customer 120. In this case, for a new customer 120 and/or resource, credentials to log in (at 305) may only be available to one or more users designated as access managers. Alternately, when a customer 120 or resource is added, the host system 110 may assign access manager or member types to an initial set of users associated with the customer 120.

At 320, if the verification is passed, a token (e.g., JWT) may be assigned to the user. The token may include a unique identifier for the user and may indicate the front-end features (e.g., specific aspects of the user interface 105) available to the user. For example, if the user has been designated as an access manager, the user interface screens 210A and 210B may be available. If the user has been designated as a member, those user interface screens may not be visible or available. As indicated in FIG. 3, the graph structure 370 is used in the token assignment. This is because the graph structure 370 defines the access and permissions that are implemented for the resources, as further discussed with reference to 360. Exemplary items defined in a token are indicated in Table 1. The list in Table 1 is not intended to be limiting, and a token used in customer access management, according to embodiments, may include fewer, different, or additional items.

TABLE 1
Exemplary items defined in a token.

| Item | What it defines |
|---|---|
| user | username |
| aud | Standard key: identifies the audience of the |
| | token, that is, who should be consuming it |
| iss | Standard key: identifies the issuer of the JWT |
| sub | Standard key: subject (userId) |
| memberof | resource for which the user is indicated as a |
| | member |
| givenName | First name used in profile |
| familyName | Last name used in profile |
| email | Users email address used in profile |
| features | Flagging of features that are available |
| id | resource identifier (e.g., for application, study, |
| | document) |
| scope | scope of access (e.g., “view”) to identified |
| | resource |
| id | resource identifier |
| exp | Standard key: Time it expires |
| iat | Standard key: Issued time |

At 330, providing user interface options corresponding to the role (i.e., user type) of the user is based on the token (assigned at 320). At 340, on the customer side, the user may access the user interface 105. At 350, if the user is designated as an access manager, the user may make selections via the user interface 105 (e.g., user interface screens 310A, 310B) to add or delete other users associated with the customer 120 or modify their permissions. In this case, at 360, the graph structure 370 may be modified to reflect the changes made at the user interface 105 (at 350). Nodes 710 associated with users may be added or removed based on users being added or removed by the user designated as an access manager (at 350). Edge values 735 may be modified based on the user designated as an access manager changing permissions (at 350).

At 380, whether the user who has logged in (at 305) is a user designated as an access manager or a member, the user may request resources through the user interface 105. At 390, verifying access and permissions of the user to the requested resources may include using the identity of the user, included in the token assigned at 320, and the graph structure 370. That is, rules defined by the graph structure 370 may be run against the identity of the user according to the token associated with the user. For example, if the node 710 associated with the identity of the user, according to the token, does not have an edge 730 to the node 720 associated with the requested resource, then the user cannot access the requested resource and may be provided an informational message. Exemplary graph structures 370 are further discussed with reference to FIGS. 7-12.

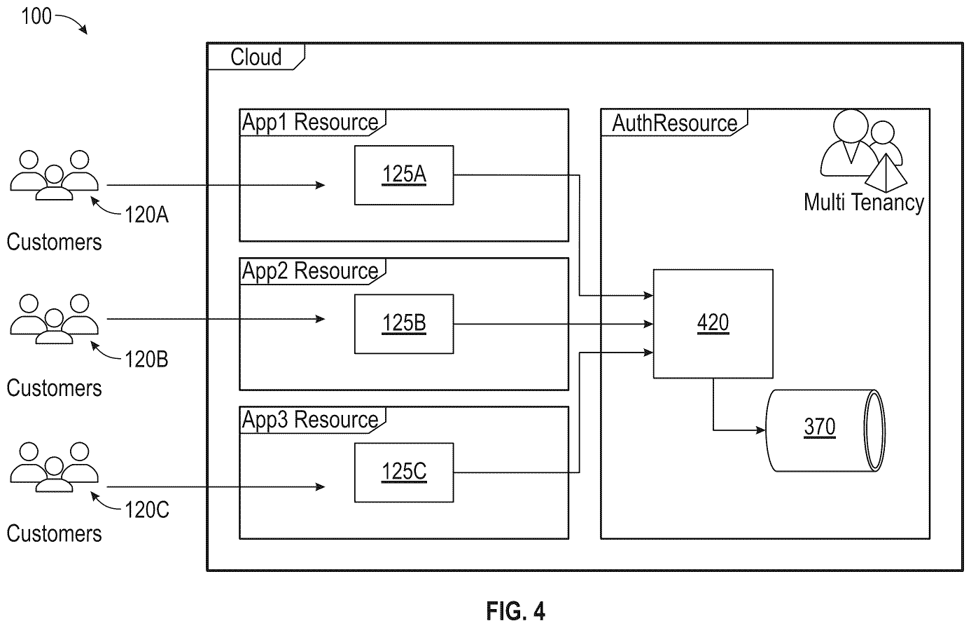

FIG. 4 shows aspects of an exemplary system 100 in which customer access management implemented via a graph structure 370 according to some embodiments. Three customers 120A, 120B, and 120C (generally referred to as 120) are shown to use a cloud-based application for respective user interfaces 125A, 125B, and 125C (generally referred to as 125). This is an example of multi-tenant SaaS because each customer 120 does not use a distinct authorization service 420 that provides access to resources according to the access and permissions defined in the graph structure 370. The authorization service 420 may refer to instructions implemented by one or more processors of the host system 110 or distributed processors within and outside the host system 110 to ultimately determine access to resources. The resources may be stored in cloud-based or other storage 140.

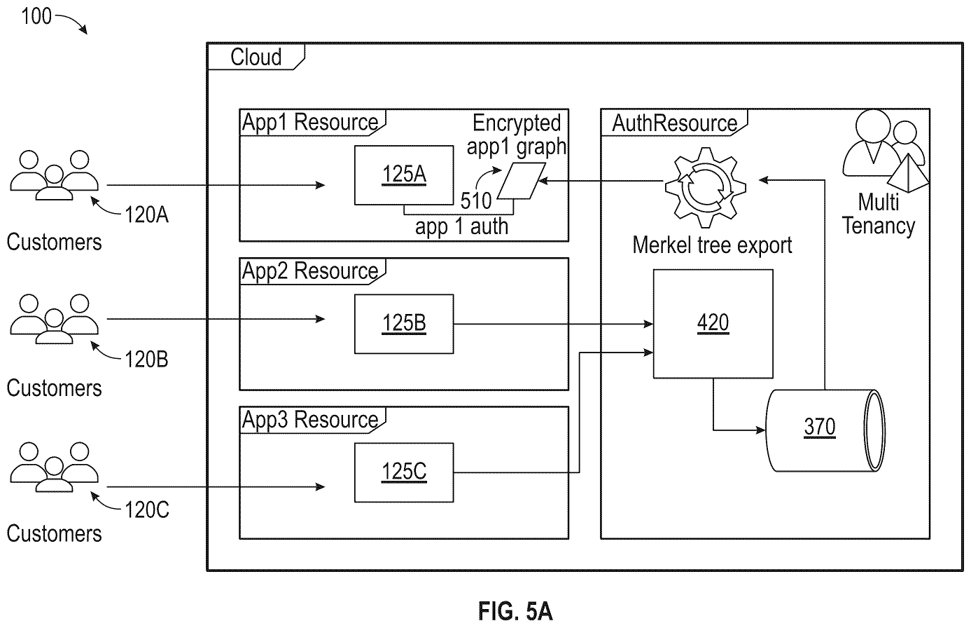

FIG. 5A shows aspects of an exemplary system 100 implementing a Merkle tree (i.e., hash tree) to decentralize the graph structure 370 according to embodiments. That is, as shown, users associated with customer 120A may have their access requests validated via an encrypted graph structure 510, specific to their enterprise, that is derived from the graph structure 370. The Merkle tree is used to ensure that the subset of the tree for distributed verification has not been modified. The host system 110 sends the subset of the tree to a client system that starts the (SaaS) application and verifies the subset against the root. If the verification passes, then the subset may be used to perform the function of the graph structure 370. This may result in faster validation and access to authorized resources as compared with the centralized access management for customer 120A shown in FIG. 4. As shown, every customer 120 need not be subject to the same approach. A centralized approach is still used with users associated with customers 120B and 120C according to the exemplary illustration in FIG. 5.

FIG. 5B shows aspects of the exemplary system of FIG. 5A in a cross-cloud implementation according to embodiments. As indicated, the user interface 125A and Merkle tree-based encrypted graph structure 510 accessed by the customer 120A is stored in a different cloud-based storage (“Cloud 2”) than the authorization service 420 and graph structure 370 (“Cloud 1”). FIG. 5B illustrates the flexibility of the customer access management architecture.

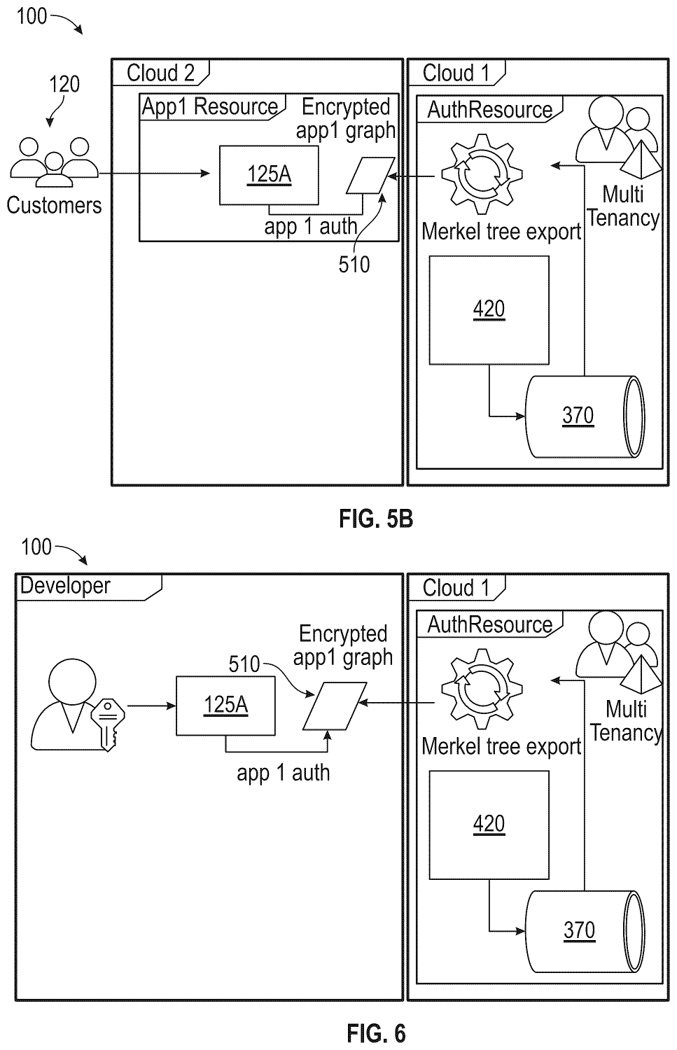

FIG. 6 shows aspects of an exemplary system 100 implementing a Merkle tree for development activity according to embodiments. A host-side user 610 is shown using a Merkle tree-based encrypted graph structure 510 to obtain local access to an application. The user 610 may build and test the application without needing to connect to the host server for verification repeatedly during development. Once the application is exported via the distributed Merke tree scheme, the user 610 may disconnect from the host system 110 and work on the exported application locally. According to a prior approach, the user 610 would need to stay connected to the cloud, virtual private network (VPN), or other environment storing the graph structure 370.

FIGS. 7-12 show exemplary graph structures 370 according to some embodiments. Labels are not repeated for each instance of a component for readability. An index of the user nodes 710 and resource nodes 720 referenced in FIGS. 7-12 is included with FIG. 7. FIG. 7 shows an exemplary graph structure 370 that may be the initial graph structure 370 generated by the host system 110 (e.g., when the customer 120 is new and/or the resource (Demo App) is new) according to some embodiments. Only one user node 710 indicated as test access manager is part of the graph structure 370. The host system 110 may have designated this user associated with the customer 120 as an initial access manager. The resource nodes 720 include the demo app, demo study 1, demo study 2, and demo study 3. The edge value 735 of the edge 730 from the test access manager user node 710 to the demo app resource node 720 defines that the user indicated as test access manager has access to the demo app. The edge values 735 of the edges 730 from the test access manager user node 710 to each of the demo study 1, demo study 2, and demo study 3 resource nodes 720 define that the user indicated as the test access manager is an owner of the demo study resources.

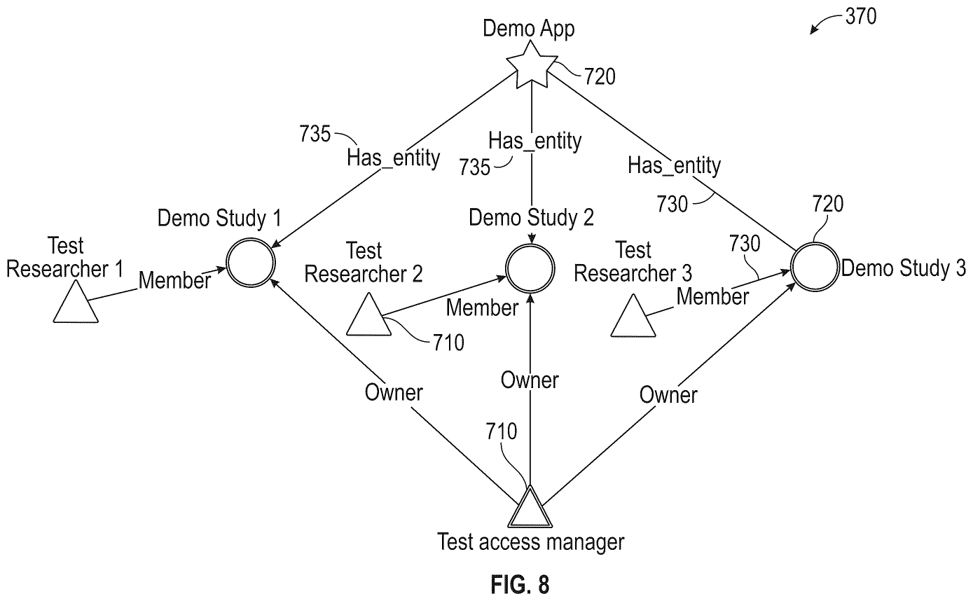

FIG. 8 shows an exemplary graph structure 370 with more user nodes 710 than in the graph structure 370 of FIG. 7. The user indicated as test access manager may have added users indicated as test researcher 1, test researcher 2, and test researcher 3 (e.g., at 350, FIG. 3) and set their type as member (e.g., using user interface screen 210A). The user indicated as test access manager may have used a user interface screen 210A with a different identifier when adding each new user. The result may be the addition of user nodes 710 indicated as test researcher 1, test researcher 2, and test researcher 3 and the edge values 735 defining each as a member. In addition, each new user node 710 has an edge 730 to only the resource node 720 corresponding to the resource identifier on the user interface screen 210A when they were added. That is, the user indicated as test researcher 1 was added as a member only to the resource identified as demo study 1. Similarly, the users indicated as test researcher 2 and test researcher 3 were only added as member to resources identified as demo study 2 and demo study 3, respectively. Although not shown for readability, the edges 730 and edge values 735 shown in FIG. 7 may be maintained in the exemplary instance shown in FIG. 8.

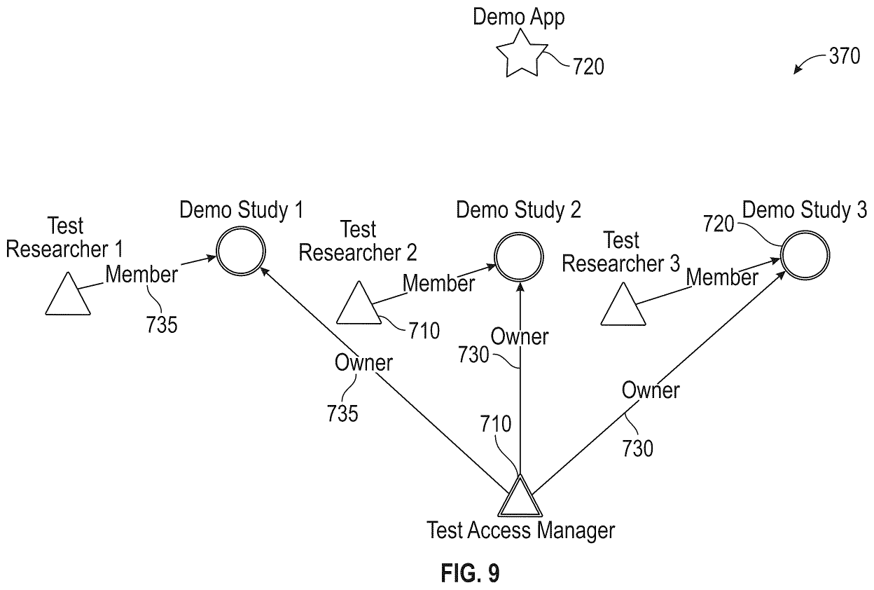

FIG. 9 shows an exemplary graph structure 370 that indicates that the demo app resource node 720 no longer has an edge 730 to another resource node 720 or a user node 710. As previously noted, the host system 110 ultimately controls access to resources. That is, while the user indicated as test access manager may modify access and permissions of other users associated with the customer 120, the access of the user indicated as test access manager to the demo app may be removed by the host system 110 (e.g., personnel at the host system 110). Thus, if the graph structure 370 in FIG. 9 was generated from the graph structure 370 shown in FIG. 8, the host system 110 may have modified access to the demo app.

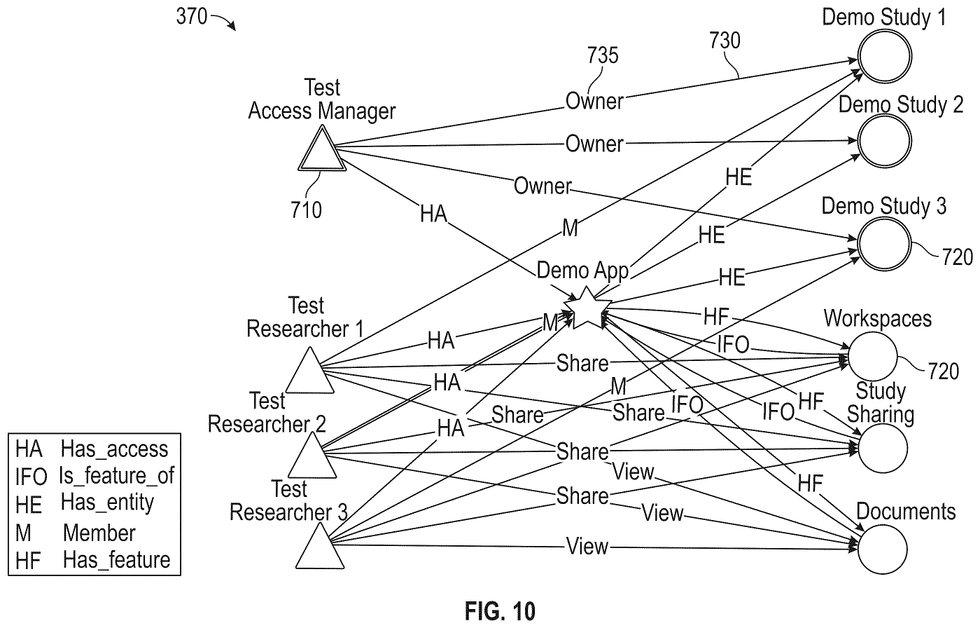

FIG. 10 shows an exemplary graph structure 370 that shows additional resources and permissions, as compared to the graph structure 370 in FIG. 9. As shown, not only the user indicated as test access manager but also the users indicated as test researcher 1, test researcher 2, and test researcher 3 have access to demo app, as defined by the edges 730 and edge values 735 from each of those user nodes 710 to the demo app resource node 720. If the graph structure shown in FIG. 10 was generated from the graph structure shown in FIG. 9, the user indicated as test access manager may have been given access to the demo app by the host system 110 and the user indicated as test access manager may subsequently have given access to the demo app to the other users. Alternately, personnel at the host system 110 may have given access to the demo app to all of the users.

FIG. 10 additionally shows resource nodes 720 not shown in the graph structure 370 of FIG. 9. Specifically, resource nodes 720 indicated as workspaces, study sharing, and documents are added with edge values 735 defining that the users test researcher 1, test researcher 2, and test researcher 3 may share workspaces and study sharing resources but only view documents indicated as the documents node 720.

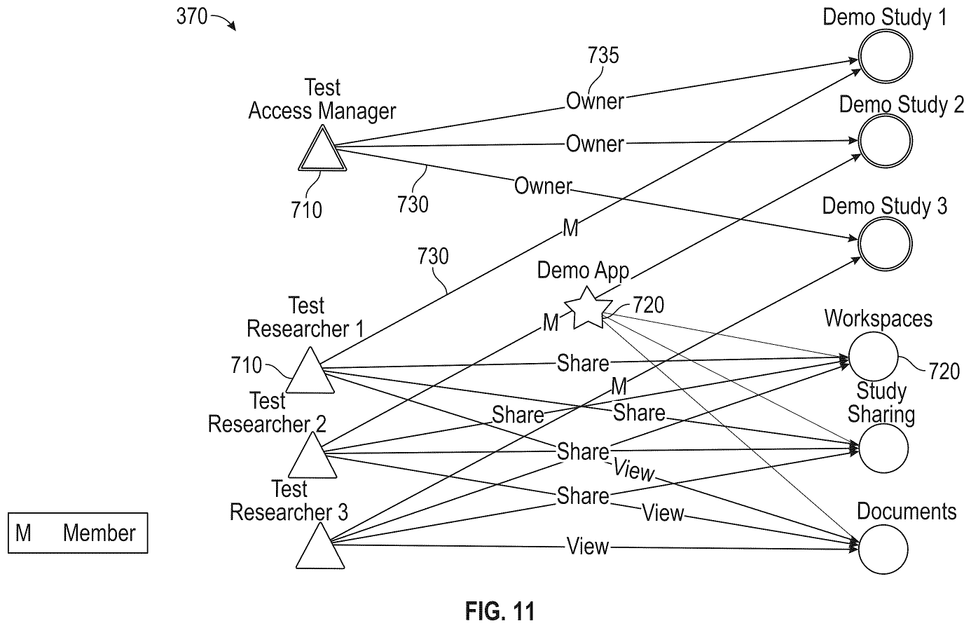

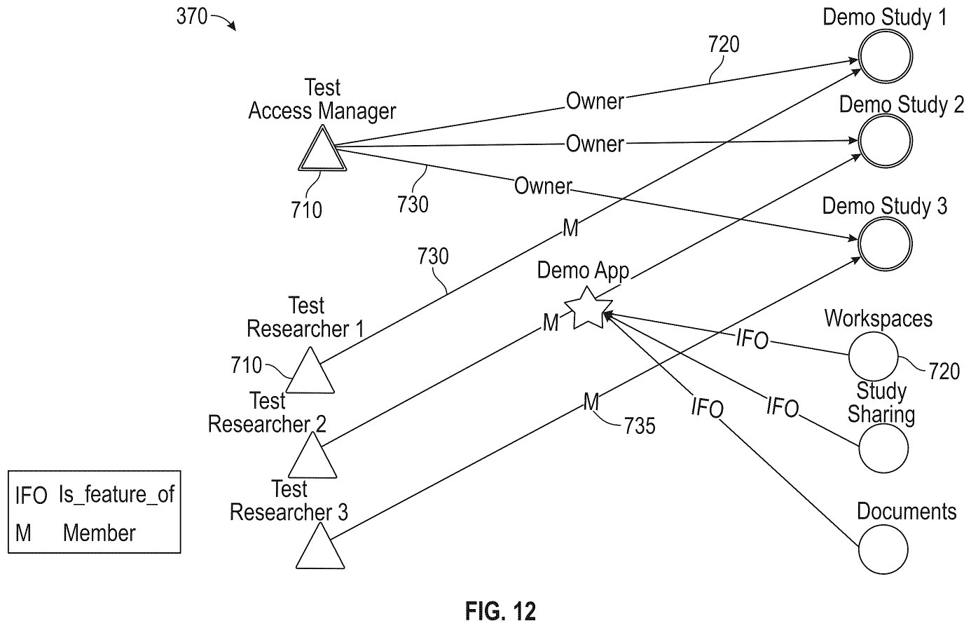

FIG. 11 shows an exemplary graph structure 370 that differs from the graph structure 370 shown in FIG. 10 in that access to the demo app, defined by edges 730 from each of the user nodes 710 to the demo app resource node 720, is removed. As previously noted, the host system 110 may remove access. FIG. 12 shows an exemplary graph structure 370 with access from test researcher 1, test researcher 2, and test researcher 3 to the workspaces, study sharing, and documents resources removed. This may result from selection on the user interface 105 by the user indicated as test access manager. In addition, these resources are linked to the demo app, a change that may be controlled by the host system 110.

Although explanatory embodiments have been described, other embodiments are possible. Therefore, the spirit and scope of the claims should not be limited to the description of the exemplary embodiments. Various modifications and variations can be made without departing from the scope and principle of the present disclosure.

What is claimed is:

1. A method of controlling access to resources provided to a customer via a host, the method comprising:
generating a graph structure defining access control to the resources, the graph structure designating a user associated with the customer as a manager, wherein
the graph structure includes a user node associated with the user designated as the manager, resource nodes, each resource node associated with a respective resource among the resources, and edges, each edge extending from the user node associated with the user designated as the manager to each of the resource nodes,
each edge specifies an edge value that defines access provided to the user designated as the manager for the respective resource among the resources, and
modifying the graph structure based on input from the user designated as the manager to modify the access control to the resources.

2. The method according to claim 1, wherein the generating the graph structure includes each edge specifying the edge value to define that the user designated as the manager is permitted to add one or more other user nodes and corresponding edges.

3. The method according to claim 2, wherein the modifying the graph structure includes adding an additional user node corresponding to an additional user associated with the customer.

4. The method according to claim 3, wherein the modifying the graph structure includes obtaining input from the user designated as the manager and adding one or more edges from the additional user node to one or more of the resources and specifying an edge value for each of the one or more edges.

5. The method according to claim 4, further comprising assigning a token to the additional user associated with the customer when the additional user associated with the customer logs in to access the resources.

6. The method according to claim 5, wherein the token is a JavaScript Object Notation (JSON) web token (JWT).

7. The method according to claim 5, wherein the token includes a unique identifier for the additional user associated with the customer and a specification of user interface features available to the additional user associated with the customer.

8. The method according to claim 4, further comprising obtaining additional input from the user designated as the manager and further modifying the graph structure based on further input from the user designated as the manager.

9. The method according to claim 8, wherein the further modifying the graph structure includes changing the edge value for one of the one or more edges from the additional user node to one of the one or more resources.

10. The method according to claim 8, wherein the further modifying the graph structure includes removing the additional user node and the one or more edges from the additional user node.

11. The method according to claim 1, further comprising removing the user node associated with the user designated as the manager from the graph structure to prevent modifying the graph structure based on input from the user designated as the manager.

12. The method according to claim 1, further comprising implementing a Merkel tree to provide decentralized access control to the resources shared by two or more customers, wherein the implementing the Merkel tree provides access control to the resources to one of the two or more customers through an encrypted graph structure not modified by others of the two or more customers.

13. A non-transitory computer-readable medium storing instructions that, when processed by one or more processors, cause the one or more processors to implement a method of controlling access to resources provided to a customer via a host, the method comprising:
generating a graph structure defining access control to the resources, the graph structure designating a user associated with the customer as a manager, wherein
the graph structure includes a user node associated with the user designated as the manager, resource nodes, each resource node associated with a respective resource among the resources, and edges, each edge extending from the user node associated with the user designated as the manager to each of the resource nodes,
each edge specifies an edge value that defines access provided to the user designated as the manager for the respective resource among the resources, and
modifying the graph structure based on input from the user designated as the manager to modify the access control to the resources.

14. The non-transitory computer-readable medium according to claim 13, wherein:
the generating the graph structure includes each edge specifying the edge value to define that the user designated as the manager is permitted to add one or more other user nodes and corresponding edges,
the modifying the graph structure includes adding an additional user node corresponding to an additional user associated with the customer, and
the modifying the graph structure also includes obtaining input from the user designated as the manager and adding one or more edges from the additional user node to one or more of the resources and specifying an edge value for each of the one or more edges.

15. The non-transitory computer-readable medium according to claim 13, wherein the method also includes assigning a token to the additional user associated with the customer when the additional user associated with the customer logs in to access the resources.

16. The non-transitory computer-readable medium according to claim 15, wherein the token includes a unique identifier for the additional user associated with the customer and a specification of user interface features available to the additional user associated with the customer.

17. The non-transitory computer-readable medium according to claim 15, wherein the method also includes obtaining additional input from the user designated as the manager and further modifying the graph structure based on further input from the user designated as the manager.

18. The non-transitory computer-readable medium according to claim 17, wherein the method further comprises:
further modifying the graph structure by changing the edge value for one of the one or more edges from the additional user node to one of the one or more resources, or
further modifying the graph structure by removing the additional user node and the one or more edges from the additional user node.

19. The non-transitory computer-readable medium according to claim 13, wherein the method also includes removing the user node associated with the user designated as the manager from the graph structure to prevent modifying the graph structure based on input from the user designated as the manager.

20. The non-transitory computer-readable medium according to claim 13, wherein the method also includes implementing a Merkel tree to provide decentralized access control to the resources shared by two or more customers, wherein the implementing the Merkel tree provides access control to the resources to one of the two or more customers through an encrypted graph structure not modified by others of the two or more customers.
